(19) United States
(12) Patent Application Publication
(10) Pub. No.: US 2025/0180892 A1
(43) Pub. Date: Jun. 5, 2025

(54) BACKSCAN STEP-AND-STARE RISLEY PRISM OPTICAL POINTING SYSTEM

(71) Applicant: BAE SYSTEMS Information and Electronic Systems Integration Inc., Nashua, NH (US)

(72) Inventors: David B. Jordan, Hollis, NH (US); Diana Tarud, Lawrence, MA (US); James L. Kingston, Temple, NH (US); Clifford D. Caseley, Hudson, NH (US)

(73) Assignee: BAE SYSTEMS Information and Electronic Systems Integration Inc., Nashua, NH (US)

(21) Appl. No.: 18/526,203

(22) Filed: Dec. 1, 2023

(51) Int. Cl. G02B 26/08; G02B 26/10; G02B 27/20

(52) U.S. Cl. CPC G02B 26/0891; G02B 26/108; G02B 27/20

(57) ABSTRACT

An apparatus and method of step-scanning frames in a field of interest (FOI) includes continuously rotating prism elements of a Risley prism assembly (RPA) while periodically rotating and resetting a fast-steering mirror (FSM) to provide static pointing during each frame. A gain factor is calculated for each frame according to actual and hypothetical prism element orientations and ray tracing, and the RPA and/or FSM rotation rates and FSM timing are adjusted accordingly. In embodiments, light from the frames is directed to a camera, and the RPA and/or FSM rotation rates and timing are adjusted to maintain adjacent frames with minimum overlap. Calculating the gain factor can include calculating hypothetical prism element rotations by a ray trace and root finding method of false position. The RPA can be achromatic. Step-scanning can be at a constant rate. Frames can be of equal duration, or of durations proportionate to their sizes.

### RELATED APPLICATIONS

This application is related to U.S. patent application Ser. No. 18/526,154, also by the present Applicant, filed concurrently with this application, which is herein incorporated by reference in its entirety for all purposes.

### FIELD

The disclosure relates to optical pointing devices, and more particularly to optical pointing devices that implement Risley prism elements.

### BACKGROUND

Many optical systems require a “pointer” to direct light from a selected location or region within a field of interest (FOI) to a “target” that is within the optical system, or vice-versa, where the terms “pointer” and “pointing system” are used herein interchangeably.

Pointing systems are sometimes required to perform “step-and-stare” pointing functions, referred to herein as “step-scanning,” wherein the pointing direction is varied in a “stepwise” manner, i.e. shifted suddenly between a series of proximate locations or “frames” along a scanning path, and held stationary in each of these locations until being transitioned to the next one.

A pointing system that implements Risley prisms, referred to herein as a Risley Prism Assembly (“RPA”) can be preferable to a Gimbal pointing system, for example in applications where space is at a premium, and/or where a low profile with a wide field of view is required. However, it can be difficult to implement step-scanning using a RPA, due to the high masses of the Risley prism elements, which hinder the rapid transitions between pointing directions that are required for step-scanning.

A “backscan” approach is sometimes implemented in Gimbal pointers to achieve step-and-stare pointing without requiring rapid, intermittent rotations of the primary pointing mirrors. According to this approach, either the input or the output of the Gimbal pointer is reflected by a “fast-steering mirror” (FSM) that has a limited range of rotation, but is small, light, and very quick to reposition. However, backscanning can be challenging for a RPA, due to the non-linearity and non-orthogonality of Risley prism elements, which greatly adds to the complexity of the FSM control algorithm.

What is needed, therefore, is an apparatus and method for implementing backscan step-scanning using a RPA that provides accurate and efficient control of the Risley scanning direction and rate, as well as accurate FSM backscanning rates and timing, while minimizing the calculation burden placed on the controller, and also minimizing the size, weight, and surge power requirements of the RPA.

### SUMMARY

The present disclosure is an apparatus and method for implementing backscan step-scanning using a Risley prism assembly (RPA) that provides accurate and efficient control of the Risley scanning direction and rate, as well as accurate FSM backscanning rates and timing, while minimizing the calculation burden placed on the controller, and also minimizing the size, weight, and surge power requirements of the RPA.

Included in the present disclosure is an optical pointing system that includes a RPA comprising a pair of prism elements that are separately rotatable about a common axis, a pair of RPA motors configured respectively to rotate the rotatable prism elements of the RPA, and a fast-steering mirror (FSM) that is rotatable by an FSM motor, wherein the RPA and FSM in combination provide for a beam of light, or light from a selected region, to be reflected by the FSM before or after passing through the RPA when traveling between a location within a field of interest (FOI) and a target. The optical pointing system further includes a controller configured to cause the RPA motors to continuously rotate the prism elements, while simultaneously causing the FSM motor to rotate the FSM, thereby optically step-scanning a scanning path.

The controller is configured to calculate a gain factor according to actual and revised orientations of the prism elements, and to adjust at least one of rotation rates of the prism elements, a rotation rate of the FSM, a rotation amplitude of the FSM, and a repetition timing of the FSM according to the calculated gain factor.

Also included in the present disclosure is a computer program product embodied on a non-transitory computer readable storage medium. The computer program product comprises instructions configured for processing scanning instructions for an optical assembly by instructing, via a controller, a pair of Risley prism assembly motors (RPA motors) to continuously rotate a respective pair of prism elements of a Risley prism assembly (RPA) while simultaneously instructing a fast steering mirror motor (FSM motor) to rotate a fast steering mirror (FSM), thereby optically step-scanning a scanning path, wherein the pair of prism elements are separately rotatable by the RPA motors about a common rotation axis, and wherein a beam of light or light from a selected region of a field of interest is reflected by the fast steering mirror before or after passing through the Risley prism assembly when traveling between the field of interest and a target. The computer program product is further configured to calculate a gain factor according to an actual and a revised orientation of the prism elements during the step-scanning, and to adjust rotation rates of the prism elements via instructions from the controller to the pair of RPA motors and adjusting at least one of a rotation rate, a rotation amplitude, and a repetition timing of the FSM via instructions from the controller to the FSM motor according to the calculated gain factor.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates refraction of a beam of light by a pair of rotatable prism elements included in a Risley prism assembly (RPA), with the prism elements oriented to provide maximum refraction of the light, according to the prior art;

FIG. 1B illustrates refraction of the beam of light by the pair of rotatable prism elements of FIG. 1A, with the prism elements oriented to provide minimum refraction of the light, according to the prior art;

FIG. 1C is a cross-sectional illustration of an achromatic Risley prism assembly in which each of the two rotatable elements includes an assembly of three prisms;

FIG. 2A is a block diagram of a backscan step-and-stare RPA optical pointing system in an embodiment of the present disclosure wherein the RPA pointing system directs a laser beam from a laser directed energy weapon (LDEW) onto a field of interest (FOI);

FIG. 2B is a block diagram of a backscan step-and-stare RPA optical pointing system in an embodiment of the present disclosure wherein the RPA pointing system directs frames of light from a FOI to a camera for acquiring images;

FIG. 2C is a block diagram of a backscan step-and-stare RPA optical pointing system in an embodiment of the present disclosure that includes two fast scanning mirrors (FSMs) executing a two-dimensional linear step-scanning pattern;

FIG. 2D is a block diagram of a backscan step-and-stare RPA optical pointing system similar to FIG. 2C, shown executing a two-dimensional non-linear step-scanning pattern;

FIG. 3 illustrates the non-linearity of an RPA pointing system as indicated by the variable sizes of the frames within a field of interest;

FIG. 4A is a block diagram that illustrates a first step in determining a gain factor for an RPA step-scanning frame according to the present disclosure;

FIG. 4B is a block diagram that illustrates a second step in determining a gain factor for an RPA step-scanning frame according to the present disclosure;

FIG. 4C is a block diagram that illustrates a third step in determining a gain factor for an RPA step-scanning frame according to the present disclosure; and

FIG. 5 is a flow diagram illustrating a method embodiment of the present disclosure.

### DETAILED DESCRIPTION

The present disclosure is an apparatus and method for implementing backscan step-scanning using a RPA that provides accurate and efficient control of the Risley scanning direction and rate, as well as accurate “Fast Steering Mirror” (FSM) backscanning rates and timing, while minimizing the calculation burden placed on the controller, and also minimizing the size, weight, and surge power requirements of the RPA.

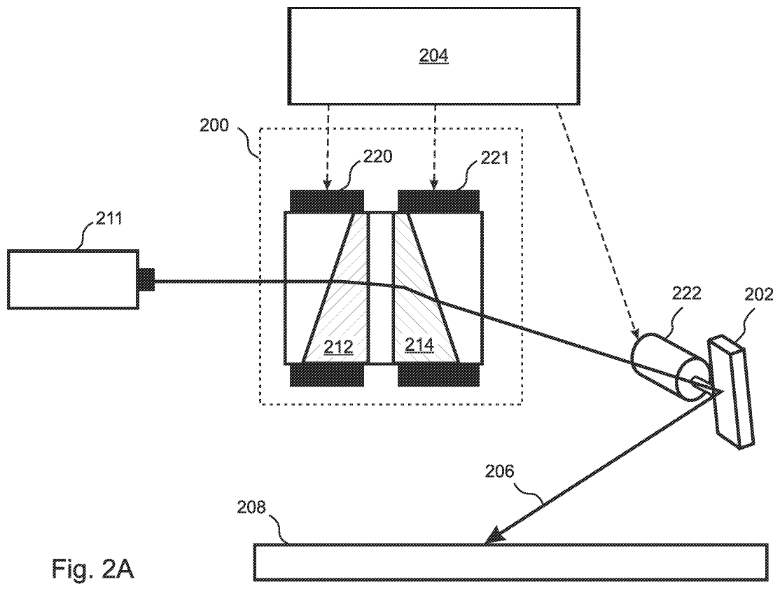

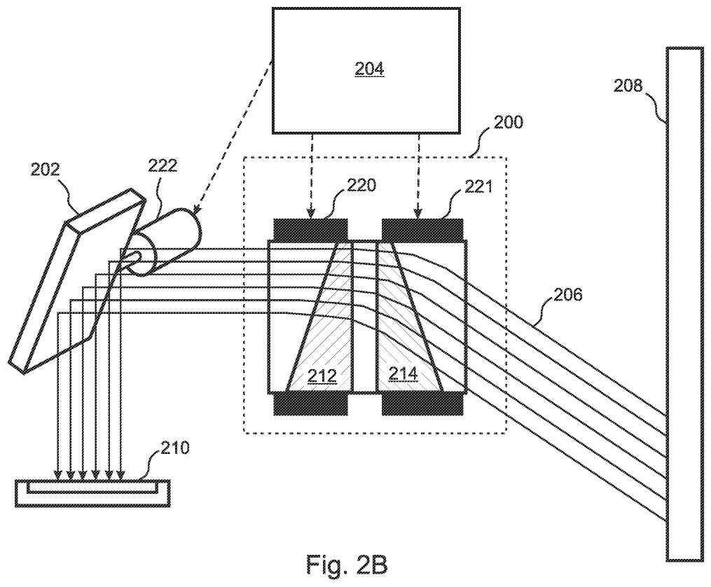

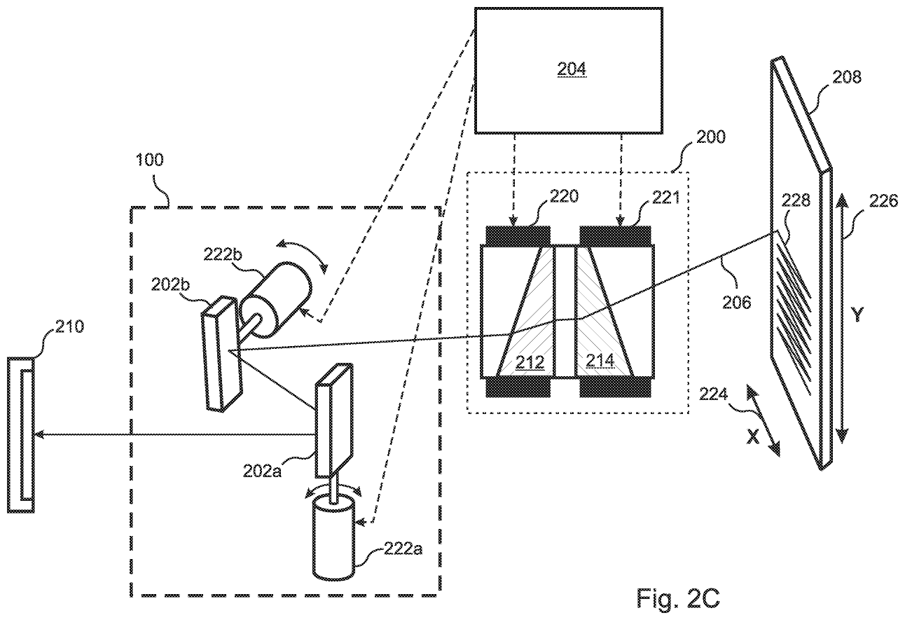

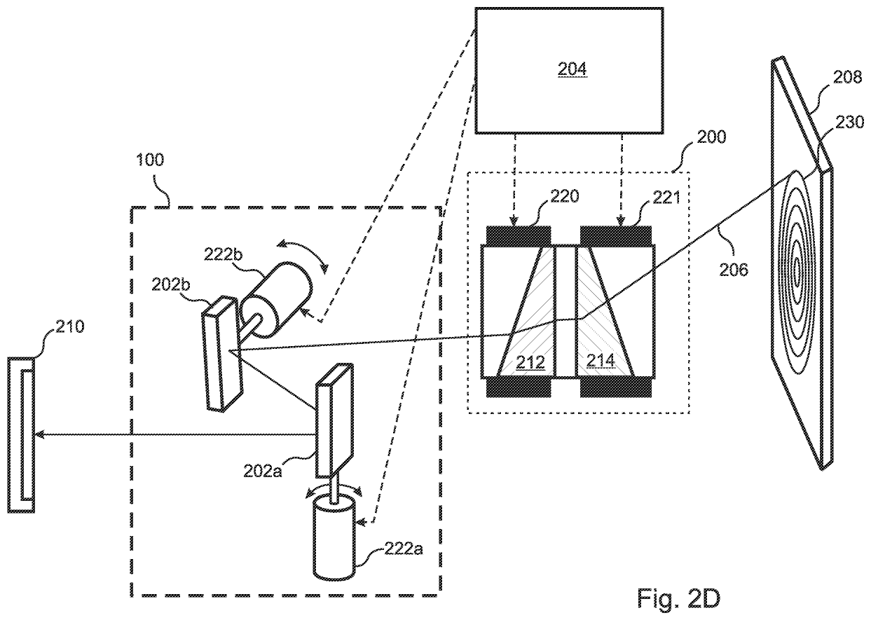

As is discussed in more detail below with reference to FIGS. 2A and 2B, some optical pointers are configured to direct a single “beam” of light, such as a laser beam, to and/or from a FOI, while other optical pointers are configured to direct “fields” of light, i.e. light from selected regions or “frames” within a FOI, to a target, such as a camera, so that optical images of the FOI can be recorded. It will be understood that examples presented herein with reference to specific types of optical pointers are intended to illustrate features that apply generically to optical systems that direct either beams of light or fields of light to and/or from a FOI, unless otherwise explicitly stated, or otherwise required by context.

For simplicity of explanation and illustration, the present disclosure is sometimes described herein in the context of a pointing system that directs successive portions or “frames” of a field of interest to a camera during successive time intervals or “steps, thereby enabling the camera to acquire images of the frames that can subsequently be assembly into a “mosaic” image of the field of interest. For example, one embodiment of the present disclosure is related to intelligence and surveillance and refers to high resolution imagery taken with a high resolution camera by scanning an area from an airborne vehicle or satellite using the present system. The mosaic resulting from the present system is a highly accurate rendition of the field of interest, such as an encampment or military ground assets.

However, it will be clear to those of skill in the art that the present disclosure is not limited to this application, and that the scope of the present disclosure extends to other embodiments that direct light in a step-wise fashion from a plurality of substantially adjacent remote locations to an internal target, and/or direct light from an internal source successively toward remote locations. A Risley pointing system can be an attractive choice for a pointing system in some applications, such as for use on low altitude aircraft and unmanned aerial vehicles, because a Risley pointing system can be conformally mounted on the aircraft skin or on a pod surface for optimal aero-optic considerations with minimal boundary layer turbulence. Furthermore, Risley pointing systems typically consume less space and require smaller apertures than gimbal pointers.

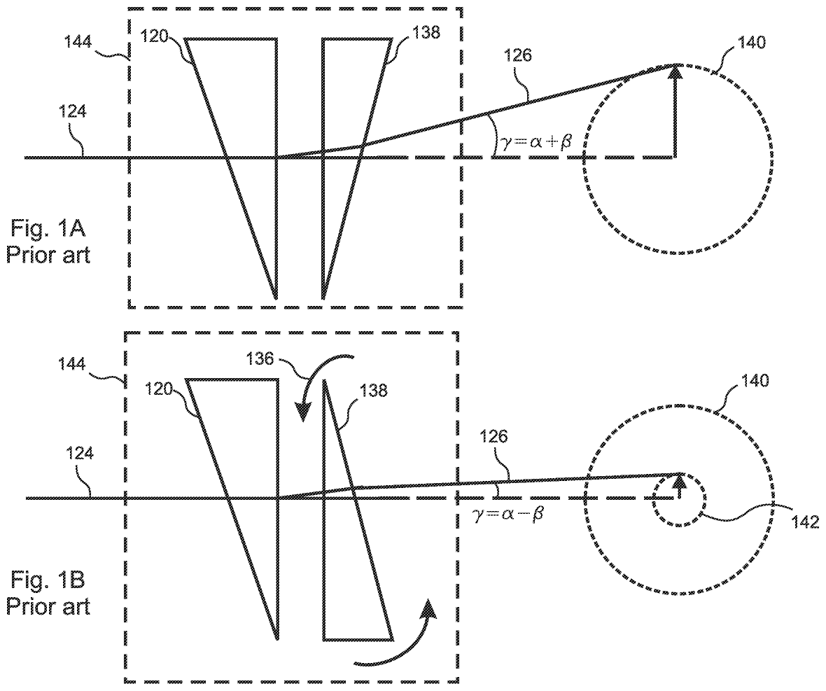

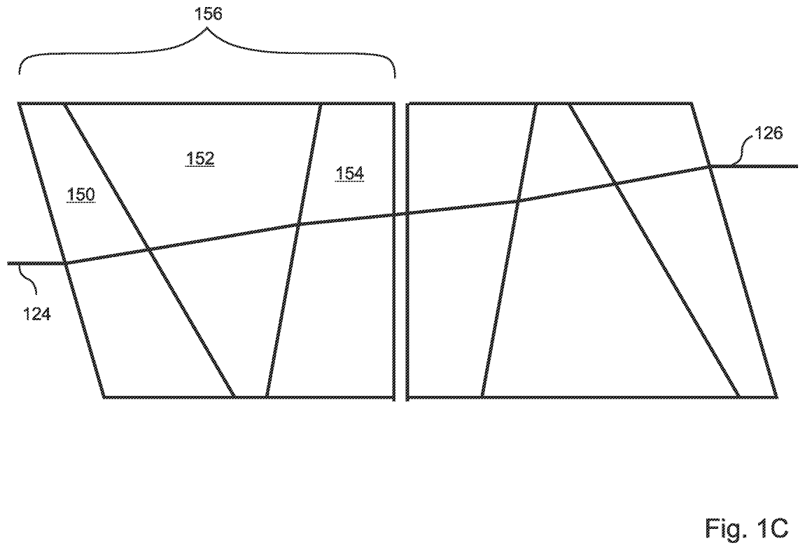

With reference to conventional FIGS. 1A and 1B, an a Risley pointing system does not redirect light by reflecting it, but instead refracts the light by passing it through a Risley prism assembly (RPA) 144, which combines at least two prism elements 120, 138 that are both independently rotatable 136 about a common axis 124. In FIG. 1B, the two prisms 120, 138 are aligned (zero degrees relative rotation 40) such that the deflection by the two prisms 120, 138 of a beam directed along the common axis 124 is cumulative, whereby the total deflection angle γ is the sum of their separate refraction angles, i.e. γ=α+β. In FIG. 1B the second prism 138 has been rotated such that the deflection of the beam by the two prisms 120, 138 is subtractive (40=180 degrees), whereby the total deflection angle γ is the difference between their separate refraction angles, i.e. γ=α−β.

By rotating both of the prisms 120, 138, the impact point of the outgoing beam 126 on a target can be directed to any point within an annular region bounded by a maximum deflection circle 140 corresponding to γ=α+β and a minimum deflection circle 142 corresponding to γ=α−β. Typically, two prisms 120, 138 having the same dispersion angle a are implemented in an RPA 144, so that the minimum deflection circle 142 is reduced to a central point, allowing the output beam 126 to be directed to a target anywhere within the disk defined by the maximum deflection circle 140. It will be noted that the pointing circles 140, 142 in FIGS. 1A and 1B are presented as if the light were directed into the page, while other elements in the drawings are presented with the light traveling in the plane of the page.

A simple Risley prism assembly as illustrated in FIGS. 1A and 1B may not be suitable for some applications, because they are inherently “chromatic,” in that the prisms 120, 138 diffract different wavelengths of light at different angles. Instead, with reference to FIG. 1C, an achromatic RPA having more than two prisms can be implemented to achieve refraction angles that are substantially independent of wavelength. An example is the achromatic RPA disclosed in U.S. Pat. No. 9,140,901, also by the present Applicant, which is incorporated herein by reference in its entirety for all purposes. In the example of FIG. 1C, the achromatic RPA implements a “pair of triplets” 156 of prisms 150, 152, 154, i.e. six prisms, where each of the “triplets” 156 comprises three prisms 150, 152, 154 that are made from different materials. Except where otherwise stated or required by context, references herein to the two “prisms” of an RPA refer generically to the two rotating elements of the RPA, whether each of the rotating elements is a singe prism 120, 138, as in FIGS. 1C and 1D, or a multiple prism assembly, such as the “triplets” 156 of FIG. 1F. For this reason, the present application sometimes refers to the rotatable elements of an RPA 144 as the “prism elements.”

With reference to FIGS. 2A and 2B, the disclosed apparatus includes a RPA 200 comprising two prism elements 212, 214 that are rotated by corresponding RPA motors 220, 221, and a fast-steering mirror (FSM) 202 that is rotated by an FSM motor 222. The RPA motors 220, 221 and the FSM motor 222 are all operated by a controller 204. In the embodiment of FIG. 2A, a single laser beam from a laser directed energy weapon (LDEW) 211 included in an aircraft is directed by the RPA 200 onto the FSM 202, and is then directed by the FSM 202 onto a field of interest (FOI) 208, such as a hostile encampment or airfield. In this example, the rapid movements of the FSM 202 enable the beam 206 to be quickly redirected to targets such as ground vehicles, in the FOI 208, while the continuous rotation of the prism elements 212, 214 of the RPA 200 compensates for movement of the aircraft over the FOI 208. Note that, in this example, the FSM 202 does not necessarily direct the beam 206 from the LDEW 211 along a continuous scanning path, but can be used instead to redirect the beam 206 from the LDEW 211 rapidly and discontinuously between various targets within the FOI 208

In the embodiment of FIG. 2B, light 206 from the FOI 208 emerges from the RPA 200 and is then directed by the FSM 202 to a camera 210. In one embodiment the FOI 208 is an enemy encampment or airfield, and the camera 210 is a high resolution camera located in a satellite or on an unmanned aerial vehicle (UAV) or other aircraft.

With reference to FIGS. 2C and 2D, embodiments include a plurality of FSMs 202a, 202b rotated by a corresponding plurality of FSM motors 222a, 222b. In the embodiment of FIG. 2C, the FSMs 202a, 202b are executing a linear two-dimensional scanning path 228 of a FOI 208, where rotation of one of the FSMs 202a shifts the scanning in the “X” direction 224, while the other of the FSMs 202b shifts the scanning in the “Y” direction 226. However, the embodiment of FIG. 2C is not limited to linear scanning paths. In FIG. 2D, the controller 204 is causing the FSM motors 222a, 222b to execute a non-linear scanning path 230, which in the illustrated example is a series of concentric circles. This scanning path 230 could be preferred, for example, if there was a danger that the scanning might be interrupted, and scanning the center of the FOI 208 was more important than scanning the periphery of the FOI 208. It will be noted that, in FIGS. 2C and 2D, the single “beam” 206 indicates the center of the frame that is being imaged by the camera 210.

According to embodiments of the disclosed method, the computational burden that is placed on the controller 204 is reduced by implementing the ray trace and root finding method of false position, referred to herein simply as the “root finding method,” that is disclosed in co-pending U.S. patent application Ser. No. 18/526,154, also by the present Applicant, filed concurrently with this application, which is incorporated herein by reference in its entirety for all purposes. The calculational simplification and accuracy of the root finding method enable the controller 204 to rapidly and accurately determine the continuously varied rates at which the Risley prism elements 212, 214 must be rotated to cause the field of interest to be continuously scanned in a desired direction, generally referred to herein as the “X” direction 112, while periodically incrementing the pointing direction in the orthogonal “Y” direction 114. It will be understood that the present disclosure can be advantageous for applications where the required accuracy of the pointing direction precludes the use of a precalculated list or table of prism rotation values.

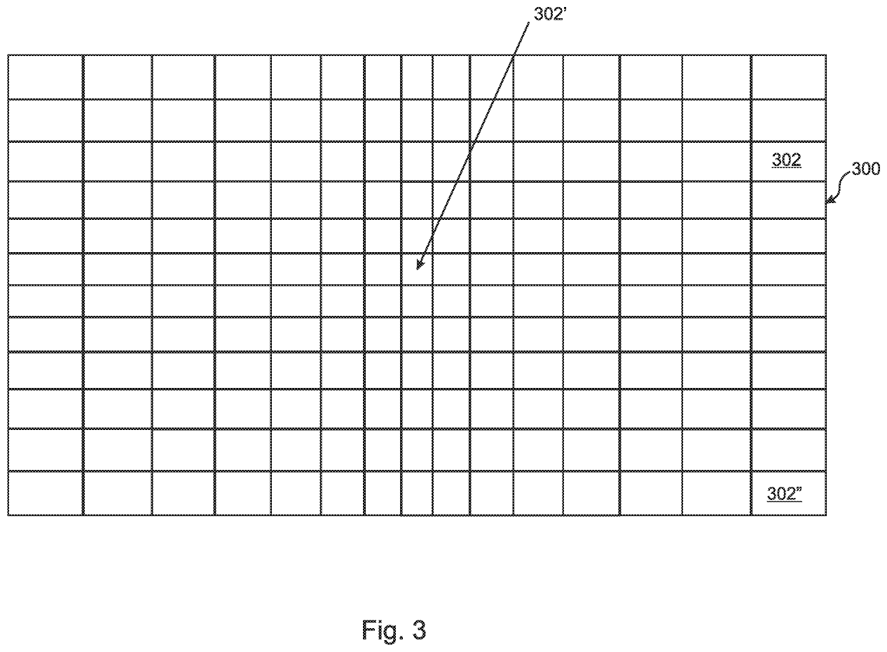

With reference to FIG. 3, in the exemplary embodiment of FIG. 2B the disclosed pointing system implements backscan step-scanning to sequentially direct portions or “frames” 302 of a field of interest 300 to a camera 210, so that the resulting “image frames” can be assembled into a mosaic image of the entire field of interest 300. The field of interest in one example is a large scene and the image is taken from an elevated position such as by an airborne vehicle or satellite. It can be seen in FIG. 3 that, due to the non-linearity of the RPA 200, the sizes of the frames 302 are greater at large pointing angles than at small pointing angles, where a “zero” pointing angle is represented by the frame at the center of the field of interest 300, which is directed to the camera 210 when the Risley prism elements are anti-aligned and impose no net deflection onto the light. In this example of 15 columns×12 rows, the center portion frames 302′ represents smaller size frames than those on the periphery 302″.

As a result, in one example it is useful to vary the ratio of Risley scan speed to the FSM scan speed as the magnitude of the pointing angle changes to stabilize each frame image. It is also useful to rotate the Risley prism elements more rapidly at larger pointing angles to compensate for the larger frame sizes and to avoid excessive overlap of the frame images.

According to the disclosed method, this non-linear effect of the RPA is taken into account by further applying the root finding method to determine a “gain factor” for each step-scanning frame. Each gain factor is calculated according to the prism element orientations at a specified moment during the frame, such as at the start of each frame. These prism element orientations are referred to herein as the “actual” prism element orientations for the frame. However, it will be noted that, in embodiments, the gain factor of each frame is determined in advance of the RPA physically reaching that frame. Accordingly, the term “actual” prism element orientations is used merely to indicate that the prism elements will “actually” occupy those orientations at some point in time, and does not necessarily imply that the Risley prism elements are physically at those orientations at the moment when the gain factor is calculated. In contrast, prism element orientations that may never be occupied by the prism elements are referred to herein as “hypothetical” orientations.

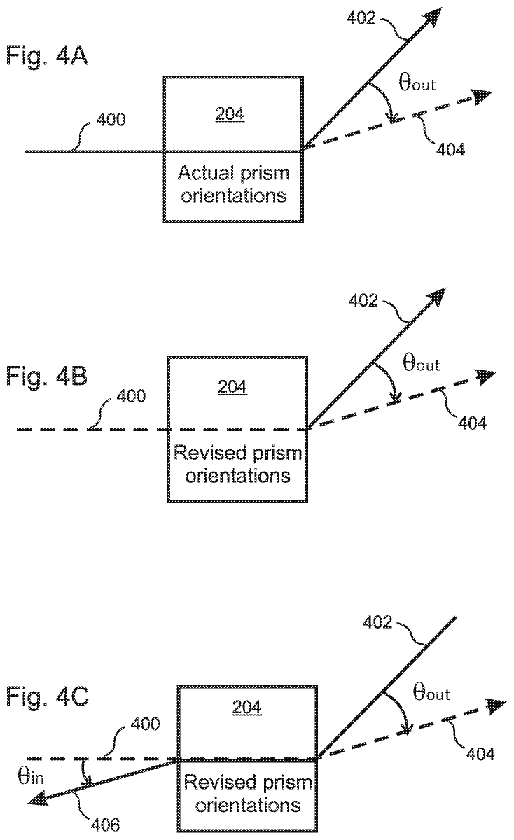

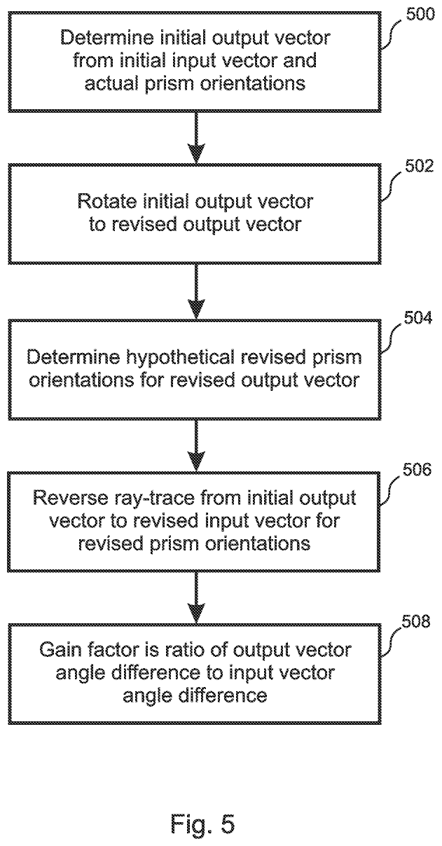

With reference to FIGS. 4A-4C and FIG. 5, determining each gain factor includes the following steps:
a. As illustrated in FIG. 4A, according to the actual orientations of the Risley prism elements, ray-tracing is used to determine 500 an “initial” output vector 402 that results from refraction by the RPA 204 of an “initial” input vector 400 that enters the RPA 204 in a forward direction along its “central axis,” i.e. along the rotational axis of the prism elements.
b. The angle between the initial output vector and the central axis is changed 502 by an arbitrary amount to define a “revised” output vector 404. In embodiments, the angle between the initial and revised output vectors is between 20 degree and 160 degrees, and in some embodiments between 45 degrees and 135 degrees.
c. As illustrated in FIG. 4B, the root finding method is used to determine 504 revised prism element orientations at which the initial input vector 400 would emerge from the RPA in the direction of the revised output vector 404. These revised prism element orientations are deemed hypothetical, in that the prism elements are not, and may never be, physically moved to the revised orientations.
d. With reference to FIG. 4C, ray-tracing is applied to the initial output vector 402 in a reverse direction 506 through the Risley prism elements 204 at their revised orientations to determine a revised input vector 406 that is not aligned with the central axis.
e. The “gain factor” for the frame is defined 508 as the ratio of the angle between the initial and revised output vectors θₒᵤₜ divided by the angle between the initial and revised input vectors θᵢₙ.

The gain factors are used to determine the sizes of the frames 302, and thereby to continuously adjust the rotation rates of the Risley prism elements 212, 214, the rotation amplitudes of the Risley prism elements 212, 214, and/or the rotation rates and/or reset timing of the FSM 202 to ensure that the frames 302 will be stationary and adjacent to each other without excessive overlap. Embodiments also adjust the duration of each frame 302 according to the gain factor. For example, in some embodiments all of the frames 302 have the same duration, while in other embodiments the durations of the frames 302 are adjusted according to the frame sizes.

In one example, it may be desirable for an unmanned aerial vehicle (UAV) flying at a relatively slow speed and low altitude over a field of interest that is a hostile encampment or airfield to obtain a mosaic image of the FOI, wherein the mosaic is obtained as swiftly as possible, and wherein each of the frames is equally exposed, i.e. each pixel in the mosaic results from substantially the same amount of captured light, assuming uniform illumination of the FOI. If the disclosed gain factor were not applied, then the centers of the frames would be equally spaced within the FOI, and the scanning rates of the FSM scans would be constant for all of the frames. Due to the non-linearity of the RPA, the frame sizes would be larger near the periphery of the mosaic, resulting in significant overlap of the frames near the periphery, and unnecessarily extending the amount of time required to obtain the mosaic. Also, the pixels in non-overlapping regions near the periphery of the mosaic would result from significantly less exposure times, as compared to the pixels near the center of the mosaic.

Instead, in this example, the controller will specify the rotation amplitudes of the RPA prism elements such that the distances between the centers of the frames are multiplied by their gain factors, and thereby spaced further apart near the periphery of the mosaic. For example, if the gain factor is equal to 1.0 for frames of width W at the center of the FOI, and equal to 1.4 at the extreme left and right peripheral regions of the FOI, then the controller will specify the RPA rotations such that the centers of the frames are spaced apart by approximately W near the center of the mosaic, and by approximately 1.4 W near the periphery of the mosaic. As a result, the frame overlap will be reduced, and fewer frames will be required to cover the FOI, thereby reducing the time required to obtain the mosaic. Also, in this example, the controller will divide the FSM scanning rates by the gain factors of the frames, so that frames near the periphery of the FOI will be scanned at a rate that is 40% less than at the center of the FOI, thereby compensating for the larger frame sizes at the periphery of the mosaic and causing the exposure times for all of the pixels in the mosaic to be the same.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An optical pointing system comprising:
a Risley prism assembly (RPA) comprising a pair of prism elements that are separately rotatable about a common axis;
a pair of RPA motors configured respectively to rotate the rotatable prism elements of the RPA;
a fast-steering mirror (FSM) that is rotatable by an FSM motor, wherein the RPA and FSM in combination provide for a beam of light, or light from a selected region, to be reflected by the FSM before or after passing through the RPA when traveling between a location within a field of interest (FOI) and a target; and
a controller configured to cause the RPA motors to continuously rotate the prism elements, while simultaneously causing the FSM motor to rotate the FSM, thereby optically step-scanning a scanning path;
wherein the controller is configured to calculate a gain factor according to actual and revised orientations of the prism elements, and to adjust at least one of rotation rates of the prism elements, a rotation rate of the FSM, a rotation amplitude of the FSM, and a repetition timing of the FSM according to the calculated gain factor.

2. The optical pointing system of claim 1, wherein calculating the gain factor comprises:
according to actual orientations of the prism elements, calculating a deflection angle α of a first hypothetical beam of light emerging from the RPA along an initial output vector after entering the RPA along an initial input vector that is collinear with a common rotational axis of the prism elements, α being an angle formed between the initial output vector and the common rotational axis of the prism elements;
hypothetically rotating the initial output vector to a revised output vector, wherein an angle θₒᵤₜ is formed between the initial output vector and the revised output vector;
calculating hypothetical revised orientations of the prism elements for which the first hypothetical beam of light would emerge from the RPA along the revised output vector;
according to the hypothetical revised orientations of the prism elements, calculating a revised input vector along which a second hypothetical beam of light would emerge from the RPA after entering the RPA in a reverse direction along the initial output vector, wherein an angle θᵢₙ is formed between the revised input vector and the initial input vector; and
calculating the gain factor as being equal to θₒᵤₜ divided by θᵢₙ.

3. The optical pointing system of claim 2, wherein calculating hypothetical revised orientations of the prism elements includes performing a ray trace and root finding method of false position calculation.

4. The optical pointing system of claim 1, wherein the optical pointing system comprises a plurality of FSMs, and wherein the optical pointing system is able to step-scan the scanning path when the scanning path is not linear.

5. The optical pointing system of claim 1, wherein the RPA is achromatic, and wherein each of the prism elements comprises a plurality of prisms.

6. The optical pointing system of claim 1, wherein the target is a camera, and wherein the optical pointing system is configured to direct light from frames along the scanning path to the camera.

7. The optical pointing system of claim 6, wherein periodically calculating the gain factor includes, calculating a gain factor for each of the frames.

8. The optical pointing system of claim 6, wherein optically step-scanning the scanning path includes adjusting at least one of the rotation rates of the prism elements, the rotation rate of the FSM, a rotation amplitude of the FSM, and the reset timing of the FSM according to the gain factor to maintain successive of the frames adjacent to each other while minimizing overlap between the frames.

9. The optical pointing system of claim 6, wherein the controller is configured to direct the light from the frames to the camera during equal time durations, regardless of changes in the gain factor.

10. The optical pointing system of claim 6, wherein the controller is configured to direct the light from the frames to the camera during time durations that are proportionate to changes in the frame sizes.

11. A computer program product embodied on a non-transitory computer readable storage medium, the computer program product comprising instructions configured for processing scanning instructions for an optical assembly by:
instructing, via a controller, a pair of Risley prism assembly motors (RPA motors) to continuously rotate a respective pair of prism elements of a Risley prism assembly (RPA) while simultaneously instructing a fast steering mirror 6 motor (FSM motor) to rotate a fast steering mirror (FSM), thereby optically step-scanning a scanning path, wherein the pair of prism elements are separately rotatable by the RPA motors about a common rotation axis, and wherein a beam of light or light from a selected region of a field of interest is reflected by the fast steering mirror before or after passing through the Risley prism assembly when traveling between the field of interest and a target;
calculating a gain factor according to an actual and a revised orientation of the prism elements during the step-scanning; and
adjusting rotation rates of the prism elements via instructions from the controller to the pair of RPA motors and adjusting at least one of a rotation rate, a rotation amplitude, and a repetition timing of the FSM via instructions from the controller to the FSM motor according to the calculated gain factor.

12. The computer program product of claim 11, wherein calculating the gain factor comprises:
according to actual orientations of the prism elements, calculating a deflection angle α of a first hypothetical beam of light emerging from the RPA along an initial output vector after entering the RPA along an initial input vector that is collinear with a common rotational axis of the prism elements, α being an angle formed between the initial output vector and the common rotational axis of the prism elements;
hypothetically rotating the initial output vector to a revised output vector, wherein an angle θₒᵤₜ is formed between the initial output vector and the revised output vector;
calculating hypothetical revised orientations of the prism elements for which the first hypothetical beam of light would emerge from the RPA along the revised output vector;
according to the hypothetical revised orientations of the prism elements, calculating a revised input vector along which a second hypothetical beam of light would emerge from the RPA after entering the RPA in a reverse direction along the initial output vector, wherein an angle θᵢₙ is formed between the revised input vector and the initial input vector; and
calculating the gain factor as being equal to θₒᵤₜ divided by θᵢₙ.

13. The computer program product of claim 12, wherein calculating hypothetical revised orientations of the prism elements includes performing a ray trace and root finding method of false position calculation.

14. The computer program product of claim 11, wherein the optical pointing system comprises a plurality of FSMs, and wherein the optical pointing system is able to step-scan the scanning path when the scanning path is not linear.

15. The computer program product of claim 11, wherein the RPA is achromatic, and wherein each of the prism elements comprises a plurality of prisms.

16. The computer program product of claim 11, wherein the target is a camera, and wherein optically step-scanning the scanning path includes directing light from frames along the scanning path to the camera.

17. The computer program product of claim 16, wherein periodically calculating the gain factor includes, for each of the frames, calculating a gain factor that is applicable thereto.

18. The computer program product of claim 16, wherein optically step-scanning the scanning path includes adjusting rotation rates of the prism elements and the rotation rate and repetition timing of the FSM according to the gain factor to maintain successive frames adjacent to each other while minimizing overlap between the frames.

19. The computer program product of claim 16, wherein directing the light from the frames to the camera includes directing the light from the frames to the camera during equal durations regardless of changes in the gain factor.

20. The computer program product of claim 16, wherein the directing the light from the frames to the camera includes directing the light from the frames to the camera during durations that are proportionate to changes in the frame sizes.
